(19) United States
(12) Patent Application Publication
(10) Pub. No.: US 2025/0115278 A1
(43) Pub. Date: Apr. 10, 2025

(54) GENERATING ADVERSARIAL DRIVING SCENARIOS FOR AUTONOMOUS VEHICLES

(71) Applicant: NEC Laboratories America, Inc., Princeton, NJ (US)

(72) Inventors: Francesco Pittaluga, Los Angeles, CA (US); Buyu Liu, Cupertino, CA (US); Manmohan Chandraker, Santa Clara, CA (US); Kaiyuan Zhang, San Jose, CA (US)

(21) Appl. No.: 18/905,695

(22) Filed: Oct. 3, 2024

Related U.S. Application Data
(60) Provisional application No. 63/542,376, filed on Oct. 4, 2023.

(51) Int. Cl. B60W 60/00

(52) U.S. Cl. CPC B60W 60/0013; B60W 60/0027

(57) ABSTRACT

Systems and methods for generating adversarial driving scenarios for autonomous vehicles. An artificial intelligence model can compute an adversarial loss function by minimizing the distance between predicted adversarial perturbed trajectories and corresponding generated neighbor future trajectories from input data. A traffic violation loss function can be computed based on observed adversarial agents adhering to driving rules from the input data. A comfort loss function can be computed based on the predicted driving characteristics of adversarial vehicles relevant to comfort of hypothetical passengers from the input data. A planner module can be trained for autonomous vehicles based on a combined loss function of the adversarial loss function, the traffic violation loss function and the comfort loss function to generate adversarial driving scenarios. An autonomous vehicle can be controlled based on trajectories generated in the adversarial driving scenarios.

### RELATED APPLICATION INFORMATION

This application claims priority to U.S. Provisional App. No. 63/542,376, filed on Oct. 4, 2023, incorporated herein by reference in its entirety.

### BACKGROUND

### Technical Field

The present invention relates to controlling autonomous vehicles and more particularly to generating adversarial driving scenarios for autonomous vehicles.

### Description of the Related Art

Autonomous driving vehicles have significantly improved over the years in terms of driving capability, comfort, and safety. Despite these improvements however, autonomous driving is still not recommended as the driving capability of autonomous vehicles still lags behind human drivers in terms of comfort and safety.

### SUMMARY

According to an aspect of the present invention, a computer-implemented method is provided for generating adversarial driving scenarios for autonomous vehicles, including computing an adversarial loss function by minimizing the distance between predicted adversarial perturbed trajectories and corresponding generated neighbor future trajectories from input data using an artificial intelligence model, computing a traffic violation loss function based on observed adversarial agents adhering to driving rules from the input data, computing a comfort loss function based on the predicted driving characteristics of adversarial vehicles relevant to comfort of hypothetical passengers from the input data, training a planner module for autonomous vehicles based on a combined loss function of the adversarial loss function, the traffic violation loss function and the comfort loss function to generate adversarial driving scenarios, and generating trajectories in the adversarial driving scenarios to control an autonomous vehicle.

According to another aspect of the present invention, a system is provided for generating adversarial driving scenarios for autonomous vehicles, including, a memory device, one or more processor devices operatively coupled with the memory device to compute an adversarial loss function by minimizing the distance between predicted adversarial perturbed trajectories and corresponding generated neighbor future trajectories from input data using artificial intelligence model, compute a traffic violation loss function based on observed adversarial agents adhering to driving rules from the input data, compute a comfort loss function based on the predicted driving characteristics of adversarial vehicles relevant to comfort of hypothetical passengers from the input data, train a planner module for autonomous vehicles based on a combined loss function of the adversarial loss function, the traffic violation loss function and the comfort loss function to generate adversarial driving scenarios, and generate trajectories in the adversarial driving scenarios to control an autonomous vehicle.

According to yet another aspect of the present invention, a non-transitory computer program product is provided including a computer-readable storage medium including program code for generating adversarial driving scenarios for autonomous vehicles, wherein the program code when executed on a computer causes the computer to compute an adversarial loss function by minimizing the distance between predicted adversarial perturbed trajectories and corresponding generated neighbor future trajectories from input data using an artificial intelligence model, compute a traffic violation loss function based on observed adversarial agents adhering to driving rules from the input data, compute a comfort loss function based on the predicted driving characteristics of adversarial vehicles relevant to comfort of hypothetical passengers from the input data, train a planner module for autonomous vehicles based on a combined loss function of the adversarial loss function, the traffic violation loss function and the comfort loss function to generate adversarial driving scenarios, and generate trajectories in the adversarial driving scenarios to control an autonomous vehicle.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level overview of a method for generating adversarial driving scenarios for autonomous vehicles, in accordance with an embodiment of the present invention;

FIG. 2 is a block diagram illustrating an artificial intelligence model framework for generating adversarial driving scenarios for autonomous vehicles, in accordance with an embodiment of the present invention;

FIG. 3 is a block diagram illustrating a system for computing heuristic-based loss functions, in accordance with an embodiment of the present invention;

FIG. 4 is a block diagram illustrating a system for generating adversarial driving scenarios for autonomous vehicles, in accordance with an embodiment of the present invention;

FIG. 5 is a block diagram illustrating a system that implements practical applications of generating adversarial driving scenarios for autonomous vehicles, in accordance with an embodiment of the present invention; and

FIG. 6 is a block diagram illustrating a deep neural network for generating adversarial driving scenarios for autonomous vehicles, in accordance with an embodiment of the present invention.

### DETAILED DESCRIPTION OF PREFERRED EMBODIMENTS

In accordance with embodiments of the present invention, systems and methods are provided for generating adversarial driving scenarios for autonomous vehicles.

In an embodiment, trajectories for adversarial driving scenarios for controlling autonomous vehicles can be generated. To generate adversarial driving scenarios, a planner module for autonomous vehicles can be trained to generate the adversarial driving scenarios based on a combined loss function of an adversarial loss function, a traffic violation loss function and a comfort loss function. An autonomous vehicle can be controlled based on the trajectories for the adversarial driving scenarios.

To compute the adversarial loss function, a single representation model (ALAN) framework can minimize the distance between predicted adversarial perturbed trajectories and corresponding generated neighbor future trajectories from ground-truth trajectories of a target vehicle and neighbor vehicles, and a scene map.

To compute the traffic violation loss function, adversarial agents adhering to driving rules can be predicted from the ground-truth trajectories of the target vehicle and the neighbor vehicles, and the scene map.

To compute the comfort loss function, driving characteristics of adversarial vehicles relevant to the comfort of hypothetical passengers can be predicted from the ground-truth trajectories of the target vehicle and the neighbor vehicles, and the scene map.

Planners for autonomous vehicles (AVs) are essentially the “brains” that decide the actions an autonomous vehicle should take in a given scenario. They are responsible for generating safe, feasible paths that the vehicle can follow, considering various aspects such as static and dynamic obstacles, road rules, passenger comfort, and many more. For this reason, planners for autonomous vehicles are components that are rigorously designed, tested, and validated to ensure safe and efficient operation. Such rigorous designing and testing typically requires huge, often infeasible, data collection efforts to capture the full range of possible driving scenarios. This motivates the need for the development of novel methods for rigorously designing and testing AV planners without required such large amounts of real-world driving data. Once such family of methods aim to automatically generate adversarial driving scenarios specifically designed to challenge, evaluate, or even exploit the vulnerabilities of AV planners. However, with existing methods, these adversarial examples lack realism and diversity, which limits their utility for improving real-world planners.

The present embodiments develop a novel approach for automatically generating realistic and diverse adversarial driving scenarios for AV planners. Existing approaches rely on a simple bicycle model and/or variational autoencoders to model traffic motion. However, the former leads to adversarial trajectories lacking in realism and the latter to trajectories lacking in diversity. To address these limitations, the present embodiments propose the use of three novel regularization functions for the adversarial perturbation process-one learning-based and two heuristics-based regularization functions.

By combining heuristics-based and learning-based regularization functions, the present embodiments can generate realistic and diverse adversarial driving scenarios for AV planners. With such realistic and diverse adversarial driving scenarios, the automated vehicles can prevent future accidents and provide a more comfortable ride for their passengers.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

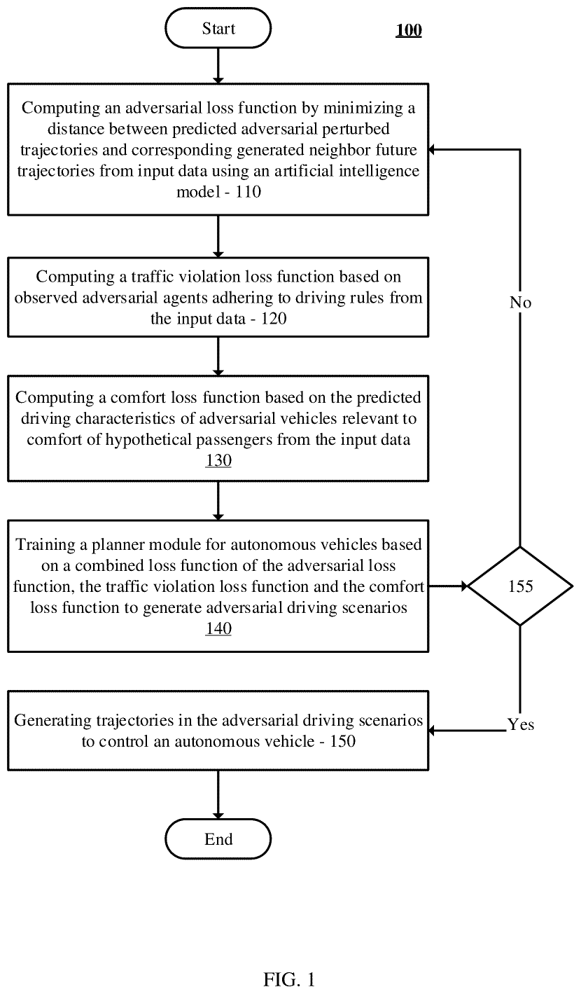

Referring now in detail to the figures in which like numerals represent the same or similar elements and initially to FIG. 1, a high-level overview of a method for generating adversarial driving scenarios for autonomous vehicles is illustratively depicted in accordance with one embodiment of the present invention.

In an embodiment, trajectories for adversarial driving scenarios for controlling autonomous vehicles can be generated. To generate adversarial driving scenarios, a planner module for autonomous vehicles can be trained to generate the adversarial driving scenarios based on a combined loss function of an adversarial loss function, a traffic violation loss function and a comfort loss function. An autonomous vehicle can be controlled based on the trajectories for the adversarial driving scenarios.

To generate adversarial perturbations, the ground-truth past and future trajectories of all vehicles in the scene and a map of the scene are fed as input into a pretrained encoder neural network to generate a scene encoding, which is used to initialize a set of learnable parameters of the same shape. The learnable parameters are then optimized (perturbed) via standard learning algorithms, such as stochastic gradient descent, to minimize a combination of losses ALAN adversarial loss function, a traffic violation loss function, adversarial collision loss function, and a comfort loss function. To compute these losses, the learnable parameters are decoded by a pretrained decoder neural network into adversarial trajectories for the neighboring agents. The adversarial perturbed trajectories can be iteratively computed until a threshold has been met.

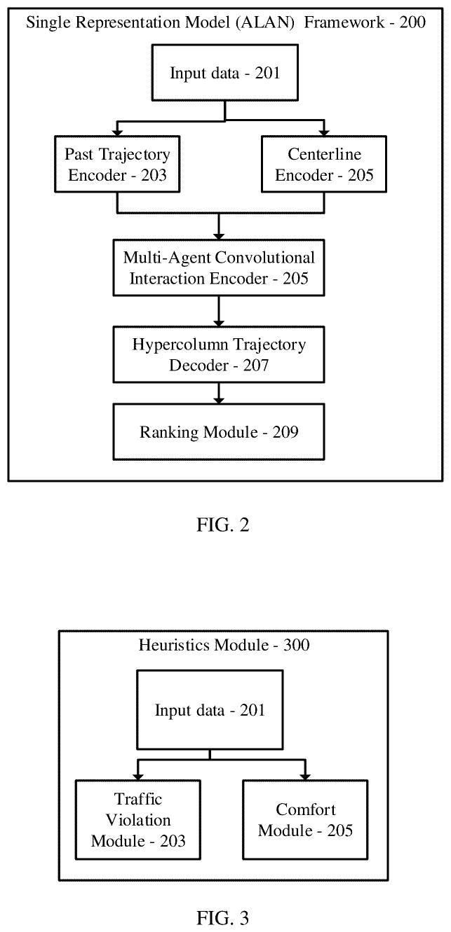

Referring now to block 110 of FIG. 1. showing a method to compute the adversarial loss function with an artificial intelligence model, a single representation model (ALAN) framework, that can minimize the distance between predicted adversarial perturbed trajectories and corresponding generated neighbor future trajectories from input data that includes ground-truth trajectories of a target vehicle and neighbor vehicles, and a scene map, in accordance to an embodiment of the present invention. The ALAN framework is described in more detail in FIG. 2.

Referring now to FIG. 2 that describes an embodiment of a system for the ALAN framework.

The ALAN framework 200 can include a centerline encoder 205, a past trajectory encoder 203, a multi-agent convolutional interaction encoder (MACIE) 205, hypercolumn trajectory decoder 207, and an inverse optimal control based ranking module 209.

The centerline encoder 205 encodes input lane information for every agent through a series of one-dimensional convolutions to produce an embedded vector for every agent in the scene.

The past trajectory encoder 203 can include a multi-layer perceptron (MLP) that can embed temporal inputs to pass to a long-short-term memory (LSTM) network to provide a past state vector.

The MACIE 205 can predict multi-agent trajectory predictions in a forward pass through a convolutional encoder module. The MACIE 205 can capture interactions at different scales when higher convolutional layers capture the global context, and low-level features retain nearby interactions.

The hypercolumn trajectory decoder 207 can regularize anchor-based outputs to make the network aware of agent dynamics and less susceptible to bad anchors by feeding a hypercolumn descriptor of every agent through a decoder containing a series of 1×1 convolutions to output M hypotheses at once.

The ranking module 209 can generate scores for the M output hypotheses from the hypercolumn trajectory decoder and rank them by assigning rewards that maximize their goals. The score loss is given as a cross entropy of the scores based on the target distribution which is a softmax distribution of the L2 distance between the ground truth and predicted outputs.

To compute ALAN trajectory predictions, ground-truth past trajectories of all vehicles in the scene and a map of the scene are fed into the pre-trained trajectory prediction neural network of the ALAN framework 200. The ALAN trajectory predictions include multiple diverse future trajectory predictions for the neighboring agents.

The ALAN Adversarial Loss can be a function that computes the distance between the adversarially perturbed trajectories, and the corresponding trajectories predicted by the ALAN framework 200. The ALAN framework 200 generates diverse yet realistic trajectory predictions for vehicles, so minimizing the ALAN consistency loss promotes realistic adversarial perturbations while providing flexibility (diversity) for the adversarial perturbations.

The collision adversarial loss can be a function that calculates the distance between the target vehicle and the adversarial vehicles. Minimizing this loss function encourages collisions between the adversarial vehicles and the target vehicle.

To compute the traffic violation loss function and the comfort loss function, a heuristics module can be employed. The heuristics module is described in more detail in FIG. 3.

Referring now to FIG. 3 that describes an embodiment of a system of the heuristics module.

The heuristics module 300 can include a heuristics database 301, a traffic violation module 303 and a comfort module 305. The heuristics database 301 can include the preferences, rules (e.g., traffic rules, passenger comfort rules, etc.), and penalties attached to the rules. The traffic violation module 303 can compute the traffic violation loss function based on the traffic rules and the penalties attached to violating the rules. The comfort module 305 can compute the comfort loss function based on the passenger comfort rules and preferences and the rewards attached to them.

Referring back now to block 120 of FIG. 1. showing a method to compute the traffic violation loss function, adversarial agents adhering to driving rules can be predicted from the ground-truth trajectories of the target vehicle and the neighbor vehicles, and the scene map, in accordance to an embodiment of the present invention.

The traffic violation loss can be a function that scores trajectories with respect to traffic rule violations. Minimizing this loss for adversarial vehicles encourages discovery of adversarial driving scenarios where the adversarial agents adhere to driving rules.

To compute the traffic violation loss, rewards and penalties can be defined for adhering to traffic rules and breaking traffic rules, respectively. For example, the traffic rules can include adhering to speed limit, staying within designated lanes, following stop signals, maintaining safe distance from other vehicles, and avoiding abrupt maneuvers. The reward can be defined as binary with zero for not complying and one for complying. The penalty can be weighted and can range from zero to one. The traffic violation loss can be a combined loss function of all the penalties (or rewards) given to breaking the rules (or adhering to the rules).

The safety of a passenger can be prioritized by minimizing a traffic violation loss based on a traffic violation threshold. The traffic violation threshold can vary depending on the current situation of the passenger. For example, in an emergency situation such as preventing substantial harm to a person, the loss for adhering to the speed limit can be lowered to accommodate the emergency situation. This can result in increasing the speed of the autonomous vehicle five to ten miles per hour (or kilometers per hour) more than the speed limit.

Referring now to block 130 of FIG. 1. showing a method to compute the comfort loss function, driving characteristics of adversarial vehicles relevant to the comfort of hypothetical passengers can be predicted from the ground-truth trajectories of the target vehicle and the neighbor vehicles, and the scene map, in accordance to an embodiment of the present invention.

The comfort loss can be a function that computes the discomfort of hypothetical passengers in a vehicle through comfort metrics (e.g., the jerk, acceleration, yaw rate of the vehicle, etc.) from a vehicle trajectory. Minimizing this loss promotes discovery of realistic adversarial driving scenarios where the adversarial agents exhibit measured driving behaviors. The comfort loss can be a combination of the weighted penalties ranging from zero to one derived from deviations from the comfort metrics.

The jerk of a vehicle is the rate of change of acceleration over time. The comfortable jerk can be predefined based on the preference of the hypothetical passenger. The comfort loss function can be minimized to prioritize the comfort of the passenger based on a comfort threshold. For example, the comfortable threshold for jerk can be less than one meter per second cubed.

The comfortable threshold for acceleration can be predefined based on the preference of the hypothetical passenger. For example, a passenger can be comfortable with gradual, consistent acceleration (e.g., 0.5 to 2.0 meters per second squared), while another passenger can be comfortable with sudden, fast acceleration (e.g., more than 2.0 meters per second squared).

The yaw rate of a vehicle is the rate at which the vehicle is rotating around its vertical axis. The yaw rate can be obtained from yaw sensors or from changes in heading angle over time through GPS data. A comfortable threshold for yaw rate can be predefined based on the preference of the hypothetical passenger. For example, the comfortable yaw rate can be less than 0.1 radians per second.

Referring now to block 140 of FIG. 1 that describes a method of training a planner module for autonomous vehicles based on a combined loss function of the adversarial loss function, the traffic violation loss function and the comfort loss function to generate adversarial driving scenarios to control the autonomous vehicles.

Referring now to the planner module of AV. Given the ground-truth past trajectories of all vehicles in the scene and a map of the scene, the planner produces a plan (future trajectory) for the target vehicle. The planner can be heuristics-based and/or learning-based and may have tunable parameters. After generating the adversarial driving scenarios, the planner parameters can be fine-tuned for improved performance on the adversarial driving scenarios. The planner can be trained using the combination of the ALAN adversarial loss function, a traffic violation loss function, adversarial collision loss function, and a comfort loss function to generate adversarial driving scenarios to control the autonomous vehicles.

The planner module can be iteratively trained, as shown in block 155, with newly collected input until a threshold has been met in which the method continues with block 150, if not, it goes back to block 110. For example, the threshold can be a natural number such as five, ten, twenty, etc. In another embodiment, the planner module can be continuously trained using the generated adversarial driving scenarios and feedback for the generated adversarial driving scenarios. The planner module can then retain previously learned knowledge by generating pseudo-trajectories that is based on real-world data taken by a vehicle and training with such pseudo-trajectories. Other knowledge retention methods can be utilized.

Referring now to block 150 of FIG. 1 showing an embodiment of a method of generating trajectories in the adversarial driving scenarios to control the autonomous vehicle. This block is described in more detail in FIG. 5.

Referring now to FIG. 5, a block diagram of a system showing a practical application of generating adversarial driving scenarios for autonomous vehicles, in accordance with an embodiment of the present invention.

An autonomous vehicle (AV) 500 can include sensors 503, planner 505, and advanced driver assistance system (ADAS) 507. The autonomous vehicle 500 can include motor vehicles such as cars, trucks, motorcycles, drones, or any machinery that can move.

The sensors 503 can include light detection and ranging (LiDAR) sensors, camera sensors, sound sensors, GPS sensors, yaw rate sensors, climate sensors, etc. The sensors 503 can collect the traffic scene 501. The traffic scene 501 can include the neighboring vehicles, the traffic road, the traffic conditions (e.g., weather, severity of traffic, temperature, etc.).

The planner 505 can implement the method of generating adversarial driving scenarios for autonomous vehicles 100 which can generate the adversarial driving scenarios which can be employed to generate a corrective action 509. In another embodiment, the planner 505 can be located in a remote server and can be connected to the autonomous vehicle 500 through a network.

The corrective action 509 can include slowing the vehicle, changing lanes slowly or quickly, accelerating the vehicle, turning the vehicle slowly or quickly, braking, etc. based on a trajectory generated to traverse the adversarial driving scenario. The corrective action 509 can be performed by the ADAS 507 to actually control the vehicle 500. For example, the generated adversarial driving scenario can include a scenario where the ego vehicle is in an imminent collision with another vehicle turning right (e.g., t-bone collision). Another scenario can include the ego vehicle being in an imminent collision with another vehicle head on. The trajectories generated for the adversarial driving scenarios can enable the planner 505 to generate the optimal trajectory to take to avoid the adversarial driving scenarios and control the vehicle in a safe and comfortable manner.

In another embodiment, the generated adversarial driving scenarios can be used to continuously train the planner 505 with feedback for the generated adversarial driving scenarios, where the planner 505 can retain previously learned knowledge. In another embodiment, real-world data captured using the sensors 503 can be used to generate adversarial driving scenarios to continuously train the planner 505.

By combining heuristics-based and learning-based regularization functions, the present embodiments can generate realistic and diverse adversarial driving scenarios for AV planners. With such realistic and diverse adversarial driving scenarios, the automated vehicles can prevent future accidents and provide a more comfortable ride for their passengers.

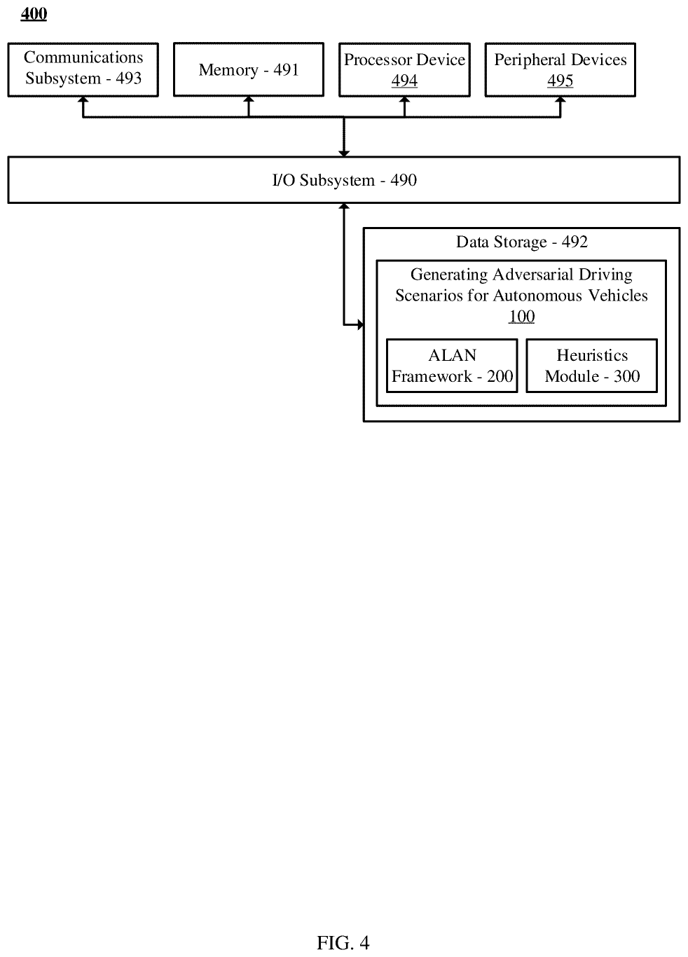

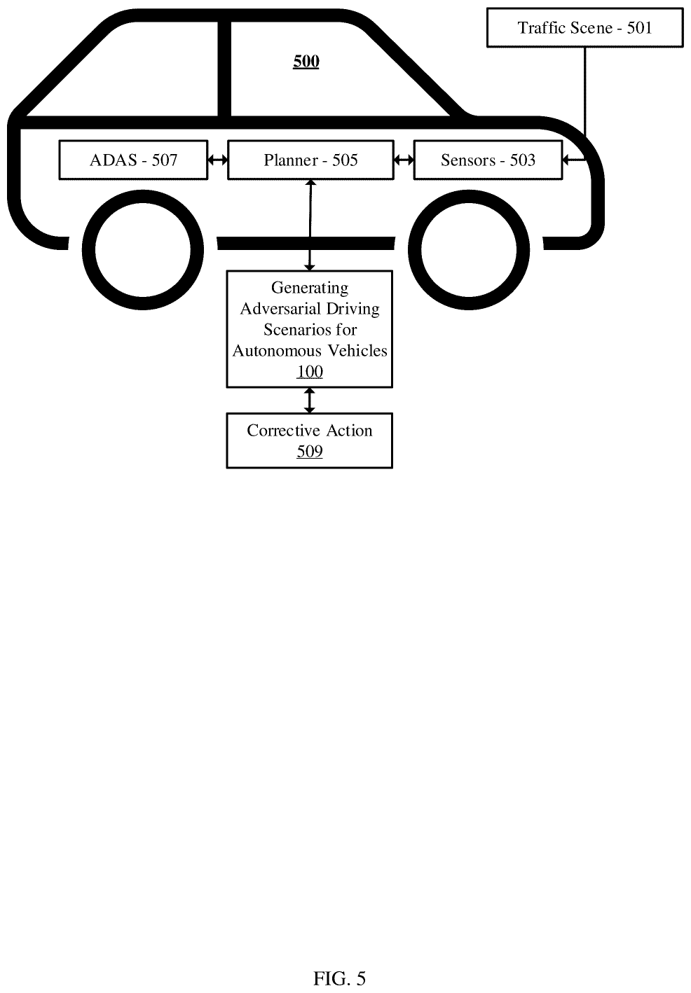

Referring now to FIG. 4, a system for generating adversarial driving scenarios for autonomous vehicles is illustratively depicted in accordance with an embodiment of the present invention.

The computing device 400 illustratively includes the processor device 494, an input/output (I/O) subsystem 490, a memory 491, a data storage device 492, and a communication subsystem 493, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 491, or portions thereof, may be incorporated in the processor device 494 in some embodiments.

The processor device 494 may be embodied as any type of processor capable of performing the functions described herein. The processor device 494 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 491 may be embodied as any type of volatile or non-volatile memory or data storage capable of performing the functions described herein. In operation, the memory 491 may store various data and software employed during operation of the computing device 400, such as operating systems, applications, programs, libraries, and drivers. The memory 491 is communicatively coupled to the processor device 494 via the I/O subsystem 490, which may be embodied as circuitry and/or components to facilitate input/output operations with the processor device 494, the memory 491, and other components of the computing device 400. For example, the I/O subsystem 490 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 490 may form a portion of a system-on-a-chip (SOC) and be incorporated, along with the processor device 494, the memory 491, and other components of the computing device 400, on a single integrated circuit chip.

The data storage device 492 may be embodied as any type of device or devices configured for short-term or long-term storage of data such as, for example, memory devices and circuits, memory cards, hard disk drives, solid state drives, or other data storage devices. The data storage device 492 can store program code for generating adversarial driving scenarios for autonomous vehicles 100. The program code generating adversarial driving scenarios for autonomous vehicles 100 can include the ALAN framework 200 and the heuristics module 300. Any or all of these program code blocks may be included in a given computing system.

The communication subsystem 493 of the computing device 400 may be embodied as any network interface controller or other communication circuit, device, or collection thereof, capable of enabling communications between the computing device 400 and other remote devices over a network. The communication subsystem 493 may be configured to employ any one or more communication technology (e.g., wired or wireless communications) and associated protocols (e.g., Ethernet, InfiniBand®, Bluetooth®, Wi-Fi®, WiMAX, etc.) to affect such communication.

As shown, the computing device 400 may also include one or more peripheral devices 495. The peripheral devices 495 may include any number of additional input/output devices, interface devices, and/or other peripheral devices. For example, in some embodiments, the peripheral devices 495 may include a display, touch screen, graphics circuitry, keyboard, mouse, speaker system, microphone, network interface, and/or other input/output devices, interface devices, GPS, camera, and/or other peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing system 400 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

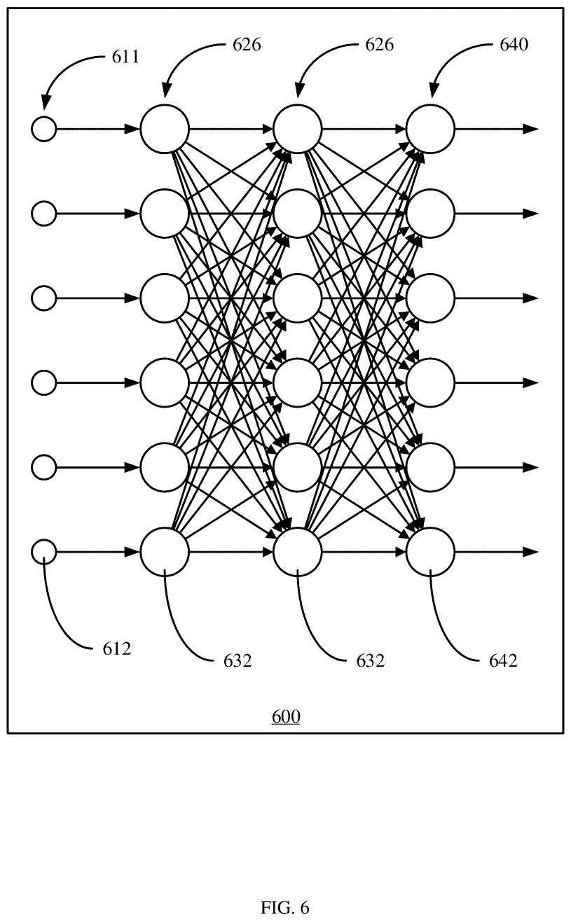

Referring now to FIG. 6, a block diagram illustrating deep learning neural networks for generating adversarial driving scenarios for autonomous vehicles, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 600, such as a multilayer perceptron, can have an input layer 611 of source nodes 612, one or more computation layer(s) 626 having one or more computation nodes 632, and an output layer 640, where there is a single output node 642 for each possible category into which the input example can be classified. An input layer 611 can have a number of source nodes 612 equal to the number of data values 612 in the input data 611. The computation nodes 632 in the computation layer(s) 626 can also be referred to as hidden layers, because they are between the source nodes 612 and output node(s) 642 and are not directly observed. Each node 632, 642 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

In an embodiment, the computation layers 626 of the ALAN framework 200 can learn the auxiliary predictions of each vehicle in a scene. The output layer 640 of the ALAN framework 200 can then provide the overall response of the network as a likelihood score of the auxiliary predictions of each vehicle in a scene.

Training a deep neural network can involve two phases, a forward phase where the weights of each node are fixed and the input propagates through the network, and a backwards phase where an error value is propagated backwards through the network and weight values are updated.

The computation nodes 632 in the one or more computation (hidden) layer(s) 626 perform a nonlinear transformation on the input data 612 that generates a feature space. The classes or categories may be more easily separated in the feature space than in the original data space.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for generating adversarial driving scenarios for autonomous vehicles, comprising:
computing an adversarial loss function by minimizing a distance between predicted adversarial perturbed trajectories and corresponding generated neighbor future trajectories from input data using an artificial intelligence model;
computing a traffic violation loss function based on observed adversarial agents adhering to driving rules from the input data;
computing a comfort loss function based on predicted driving characteristics of adversarial vehicles relevant to comfort of hypothetical passengers from the input data;
training a planner module for autonomous vehicles based on a combined loss function of the adversarial loss function, the traffic violation loss function and the comfort loss function to generate adversarial driving scenarios; and
generating trajectories in the adversarial driving scenarios to control an autonomous vehicle.

2. The computer-implemented method of claim 1, wherein computing the comfort loss function further comprises prioritizing comfort of the passenger by minimizing the comfort loss to a comfort threshold.

3. The computer-implemented method of claim 1, wherein computing the traffic violation loss function further comprises prioritizing safety of the passenger by minimizing the traffic violation loss to a traffic violation threshold.

4. The computer-implemented method of claim 1, wherein the adversarial driving scenarios further include adversarial perturbed trajectories predicted from current input data and planned ego future trajectory generated from current input data.

5. The computer-implemented method of claim 1, wherein computing the adversarial loss function further comprises generating planned ego future trajectories from ground-truth trajectories of a target vehicle and neighbor vehicles, and a scene map using the planner module.

6. The computer-implemented method of claim 1, wherein generating the trajectories further comprises employing an advanced driver assistance system to control the autonomous vehicle.

7. The computer-implemented method of claim 6, wherein generating the trajectories further comprises employing sensors to capture a current traffic scene of the autonomous vehicle.

8. A system for generating adversarial driving scenarios for autonomous vehicles, comprising:
a memory device;
one or more processor devices operatively coupled with the memory device to:
compute an adversarial loss function by minimizing a distance between predicted adversarial perturbed trajectories and corresponding generated neighbor future trajectories from input data using artificial intelligence model;
compute a traffic violation loss function based on observed adversarial agents adhering to driving rules from the input data;
compute a comfort loss function based on predicted driving characteristics of adversarial vehicles relevant to comfort of hypothetical passengers from the input data;
train a planner module for autonomous vehicles based on a combined loss function of the adversarial loss function, the traffic violation loss function and the comfort loss function to generate adversarial driving scenarios; and
generate trajectories in the adversarial driving scenarios to control an autonomous vehicle.

9. The system of claim 8, wherein to compute the comfort loss function further comprises prioritizing comfort of the passenger by minimizing the comfort loss to a comfort threshold.

10. The system of claim 8, wherein to compute the traffic violation loss function further comprises prioritizing safety of the passenger by minimizing the traffic violation loss to a traffic violation threshold.

11. The system of claim 8, wherein the adversarial driving scenarios further include adversarial perturbed trajectories predicted from current input data and planned ego future trajectory generated from current input data.

12. The system of claim 8, wherein to compute the adversarial loss function further comprises generating planned ego future trajectories from ground-truth trajectories of a target vehicle and neighbor vehicles, and a scene map using the planner module.

13. The system of claim 8, wherein to generate the trajectories further comprises employing an advanced driver assistance system to control the autonomous vehicle.

14. The system of claim 13, wherein to generate the trajectories further comprises employing sensors to capture a current traffic scene of the autonomous vehicle.

15. A non-transitory computer program product comprising a computer-readable storage medium including program code for generating adversarial driving scenarios for autonomous vehicles, wherein the program code when executed on a computer causes the computer to:
compute an adversarial loss function by minimizing a distance between predicted adversarial perturbed trajectories and corresponding generated neighbor future trajectories from input data using an artificial intelligence model;
compute a traffic violation loss function based on observed adversarial agents adhering to driving rules from the input data;
compute a comfort loss function based on predicted driving characteristics of adversarial vehicles relevant to comfort of hypothetical passengers from the input data;
train a planner module for autonomous vehicles based on a combined loss function of the adversarial loss function, the traffic violation loss function and the comfort loss function to generate adversarial driving scenarios; and
generate trajectories in the adversarial driving scenarios to control an autonomous vehicle.

16. The non-transitory computer program product of claim 15, wherein to compute the comfort loss function further comprises prioritizing comfort of the passenger by minimizing the comfort loss to a comfort threshold.

17. The non-transitory computer program product of claim 15, wherein to compute the traffic violation loss function further comprises prioritizing safety of the passenger by minimizing the traffic violation loss to a traffic violation threshold.

18. The non-transitory computer program product of claim 15, wherein the adversarial driving scenarios further include adversarial perturbed trajectories predicted from current input data and planned ego future trajectory generated from current input data.

19. The non-transitory computer program product of claim 15, wherein to compute the adversarial loss function further comprises generating planned ego future trajectories from ground-truth trajectories of a target vehicle and neighbor vehicles, and a scene map using the planner module.

20. The non-transitory computer program product of claim 15, wherein to generate the trajectories further comprises employing an advanced driver assistance system to control the autonomous vehicle.
